(19) United States
(12) Patent Application Publication
(10) Pub. No.: US 2007/0033415 A1
(43) Pub. Date: Feb. 8, 2007

(54) Locking device and key

(75) Inventors: Manabu Yumoto, Nara-shi (JP); Takayoshi Tanaka, Iga-shi (JP); Hiroyuki Horiuchi, Nara-shi (JP)

Correspondence Address: BIRCH STEWART KOLASCH & BIRCH, PO BOX 747, FALLS CHURCH, VA, 22040-0747, US

(73) Assignee: SHARP KABUSHIKI KAISHA

(21) Appl. No.: 11/498,185

(22) Filed: Aug. 3, 2006

(30) Foreign Application Priority Data
Aug. 4, 2005 (JP) 2005-226875

(51) Int. Cl. H04K 1/00

(52) U.S. Cl. 713/186

(57) ABSTRACT

A key used in a locking device includes a fingerprint sensor that acquires fingerprint information of an operator, an authentication unit that authenticates the operator based on fingerprint information acquired by the sensor when the key is inserted into a lock, and a transmitting unit that transmits a result of the authentication performed by the authentication unit to the lock. The lock includes a receiving unit that receives the authentication result transmitted from the transmitting unit, and an unlocking unit that performs unlocking when both the authentication result received by the receiving unit is information showing that authentication of the operator was established, and the inserted key and the lock are the correct combination.

### CROSS REFERENCE

This Nonprovisional application claims priority under 35 U.S.C.§ 119(a) on Patent Application No. 2005-226875 filed in Japan on Aug. 4, 2005, the entire contents of which are hereby incorporated by reference.

### BACKGROUND OF THE INVENTION

The present invention relates to a locking device suitable for hotel door keys and the like that are used by the general public and require high security, and more particularly to a locking device that performs both authentication in combination with a key and biometric authentication of the holder of the key.

Heretofore, locking devices that use biometric authentication such as fingerprint authentication have been disclosed in the following patent documents.

(1) Locking Devices Using Only Fingerprint Authentication

There are door locking devices that use only fingerprint authentication, such as that shown in JP 2002-349100A. A fingerprint sensor is embedded into the grip of a door handle of this locking device, and fingerprint information acquired by this sensor is judged with a fingerprint authentication device provided in the door. The locking device unlocks the door if authentication is established.

(2) Locking Devices Performing Both Mechanical Authentication and Fingerprint Authentication

There are door locking devices that use both mechanical authentication and fingerprint authentication, such as that shown in JP 2004-108022A. Mechanical authentication refers to authenticating an operator by judging whether the combination of key and lock is correct, and typically indicates a normal key structure. Fingerprint authentication is performed in a fingerprint authentication device provided in the door. The operator performs an operation for carrying out fingerprint authentication with the fingerprint authentication device, and a key insertion operation for carrying out mechanical authentication. The locking apparatus unlocks the door when both mechanical authentication and fingerprint authentication are established.

However, the following problems exist with locking devices that use the aforementioned biometric authentication, particularly fingerprint authentication.

(1) Locking Device Using Only Fingerprint Authentication (JP 2002-349100A)

This device may produce a fixed authentication error (approx. 0.1% for both false acceptance/false rejection), since fingerprint authentication is the only means of authentication used. Thus, there are difficulties in terms of security. Other biometric authentication systems besides fingerprint authentication are similar in this respect. Further, operators have a strong aversion to this system because the fingerprint authentication device is provided on the door, giving rise to a risk of fingerprint information being leaked externally.

(2) Locking Device Using Both Mechanical Authentication and Fingerprint Authentication (JP 2004-108022A)

Security is improved when mechanical authentication and fingerprint authentication are used together. However, convenience to the user is reduced, because a locking/unlocking operation for mechanical authentication and another operation for fingerprint authentication need to be performed separately.

Operators also have a strong aversion to this system because of the fingerprint authentication device being provided on the door, giving rise to a risk of fingerprint information being leaked externally.

### SUMMARY OF THE INVENTION

An object of the present invention is to provide a locking device that has excellent operability and prevents leaking of information belonging to individuals while at the same time avoiding a reduction in security.

A locking device according to the present invention includes a key and a lock, similarly to normal locking devices.

The key includes a biometric information acquisition sensor that acquires biometric information of an operator, an authentication unit that authenticates the operator based on biometric information acquired by the sensor when the key is inserted into the lock, and a transmitting unit that transmits a result of the authentication performed by the authentication unit to the lock.

The biometric information of the operator is authenticated within the key, and only the result of the authentication is transmitted to the lock. As a result, leaking of biometric information is prevented from occurring, making it possible to remove any aversion that operators might have.

The lock includes a receiving unit that receives the authentication result transmitted from the transmitting unit, and an unlocking unit that performs unlocking when both the authentication result received by the receiving unit is information showing that authentication of the operator was established, and the inserted key and the lock are the correct combination.

With the above configuration, the unlocking unit only performs unlocking only when both authentication of the operator and authentication of the lock/key combination (mechanical authentication) are established. Thus, a reduction in security is prevented, as is the leaking of biometric information. Further, operability is not reduced since mechanical authentication and authentication of biometric information can be performed with just a key operation.

Typically, fingerprint information is appropriate as the biometric information. Since the shape of the key allows gripping by the thumb and index finger, fingerprint information can be acquired at the same time as the key operation by providing a fingerprint information acquisition sensor on the thumb side.

The transmitting unit and the receiving unit preferably are configured to perform contactless communication. Contactless communication systems include RFID (Radio Frequency Identification), electronic tagging, and IrDA. Of course, a contact communication system with contact points can also be adopted.

As one example, the authentication unit is configured as follows to perform biometric information authentication.

The authentication unit includes a storage unit, and biometric information acquired by the biometric information acquisition sensor is stored in this storage unit as reference biometric information. The operator is authenticated by comparing biometric information acquired by the sensor when the key is inserted into the lock with the reference biometric information stored in the storage unit. Authentication is established when the reference biometric information stored in the storage unit matches the biometric information acquired by the biometric information acquisition sensor match within a prescribed tolerance. Generally, biometric information is used directly or a characterizing part of the biometric information is used.

### BRIEF DESCRIPTION OF THE DRAWINGS

FIG. 1 is a front elevational view of a key used by a locking device according to an embodiment of the present invention.

FIG. 2 is a view from the outside of a door when the locking device is applied in a door.

FIG. 3 is a view from the inside of a door when the locking device is applied in a door.

FIGS. 4A to 4C illustrate the structure and movement of a deadbolt.

FIG. 5 shows a locking/unlocking operation by an inner bolt resulting from a solenoid drive.

FIG. 6 is a block diagram of a key and a lock.

FIG. 7 is a flowchart showing the operation of the lock.

FIG. 8 is a flowchart showing the operation of the lock.

FIG. 9 is a flowchart showing the operation of the lock.

FIG. 10 is a flowchart showing the operation of the lock.

FIG. 11 shows the configuration of a fingerprint information registration device.

FIG. 12 is a flowchart showing an operation when registering fingerprint information.

FIG. 13 shows another working example of the key.

### DETAILED DESCRIPTION OF THE INVENTION

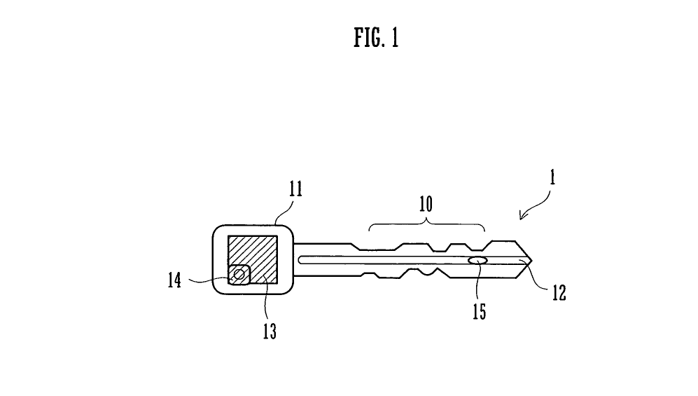

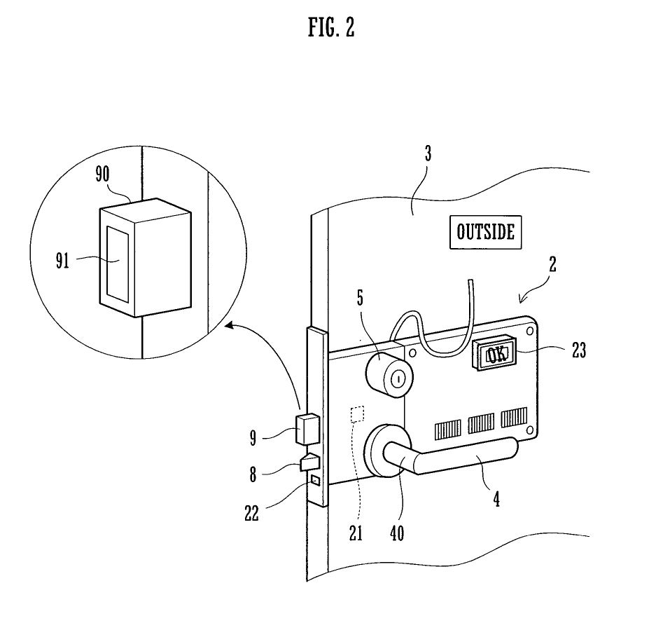

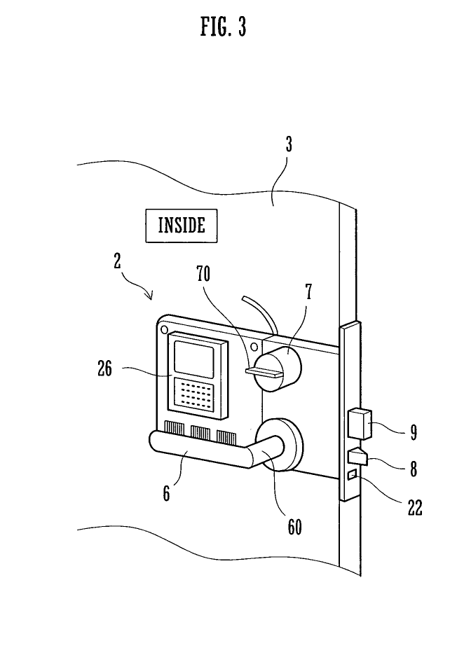

FIGS. 1 to 3 show a door locking device according to an embodiment of the present invention. FIG. 1 is a plan view of a key, while FIGS. 2 and 3 respectively show a perspective view of a lock seen from the outside of a door, and a perspective view of the lock seen from the inside of the door.

In FIG. 1, a key portion 10 is provided at the front end of a key 1 (right side portion in the figure), and a handle 11 is provided at the rear end (left side portion in the figure) of the key. The key portion 10 is provided with a groove 12 that runs in a longitudinal direction along a vertically central portion thereof.

A fingerprint sensor 13 is provided on a surface of the handle 11, while an authentication unit 14 is provided inside the handle 11. A communication unit 15 (coil for transmitting and receiving) is provided along the groove 12 near the tip of the key 1 (near the right-hand end in the figure). The communication unit 15 may be embedded in the key 1, or fixed to the wall of the groove 12 by an adhesive layer or the like. The communication unit 15 preferably is embedded in the key 1, since there is a possibility in the latter case of the communication unit 15 being removed when the key is inserted.

The fingerprint sensor 13 acquires fingerprint information of an operator. This fingerprint sensor 13 is positioned so as to contact a prescribed portion of a predetermined finger. The fingerprint sensor 13 is provided as follows in the case where it has been decided to detect the fingerprint of the ball of the thumb, for example. That is, the fingerprint sensor 13 is provided on the left side of the handle surface, so that when the operator holds the handle 11 with the right hand, the inside of the thumb on the right hand contacts the fingerprint sensor 13. In the case of a key for left-handed use, the fingerprint sensor 13 is provided on the right side of the handle surface. Providing the fingerprint sensor 13 on both sides of the handle 11 is also possible.

An authentication unit 14 for authenticating an operator based on fingerprint information acquired by the fingerprint sensor 13 is provided inside the handle 11 of the key 1. This authentication unit 14 includes a memory for prestoring reference fingerprint information that forms a basis for authentication, and judges whether fingerprint information acquired by the fingerprint sensor 13 is the same as the reference fingerprint information though comparison, as described later. A characterizing part of the reference fingerprint information is stored in the memory, and when the comparison is performed, a characterizing part of the fingerprint information acquired by the fingerprint sensor 13 is extracted and compared with the characterizing part of the reference fingerprint information stored in the memory. The two pieces of fingerprint information are judged to be the same if the difference between the characterizing parts is within a prescribed tolerance. Note that the fingerprint information may be compared directly, rather than comparing characterizing parts thereof. In the present specification, authentication of an operator may be referred to simply as fingerprint authentication.

Fingerprint information can be stored in the memory in advance using the fingerprint sensor 13. That is, a registration mode for fingerprint information is set when fingerprint information is to be stored, and fingerprint information acquired by the fingerprint sensor 13 when in the registration mode is stored in the memory as reference fingerprint information. This is described in detail later.

The result of the operator being authenticated by the authentication unit 14 is sent to the communication unit 15, and transmitted as a radio signal. Establishing authentication of the operator using fingerprint information, that is, matching a characterizing part of the fingerprint information acquired by the fingerprint sensor 13 with a characterizing part of the reference fingerprint information stored in the memory is one of the conditions for unlocking a door. As noted above, a first condition for unlocking a door is establishing authentication of the operator using fingerprint information, that is, establishing fingerprint authentication. A second condition is that the key portion 10 and a lock 2 are the correct combination, and that the key 1 rotates normally. Establishing the latter condition is referred to hereinafter as establishing mechanical authentication.

Note that the communication unit 15 performs contactless communication with the lock 2, as described later. Power required for operation is supplied by a carrier wave transmitted from the lock 2 by contactless communication, although it is possible to provide a small battery in the key 1 and supply power from this battery.

In FIG. 2, the lock 2 is provided in a door 3 of a room. The lock 2 includes an outside door handle 4 located on the outside of the door 3, and a cylinder 5 located above the outside door handle 4. A keyhole is provided in the cylinder 5, and the key 1 is inserted in this keyhole and rotated. An inside door handle 6 is provided on the inside of the door 3, symmetrically to the outside door handle 4. An outside rotating axis 40 coupled to the outside door handle 4 and an inside rotating axis 60 coupled to the inside door handle 6 are rotatably provided concentrically. The outside rotating axis 40 and the inside rotating axis 60 are coupled inside the lock 2 to a latch bolt 8 for temporary locking. The latch bolt 8 is coupled inside the lock 2 to a spring that is not shown. This spring pushes the latch bolt 8 out when an external force is not being applied to the outside door handle 4 and the inside door handle 6. When the outside door handle 4 is operated so as to rotate clockwise against the elasticity of the spring, or when the inside door handle 6 is operated so as to rotate anti-clockwise against the elasticity of the spring, the latch bolt 8 is retracted into (inside) the lock 2.

A thumb turn 7 is provided on the inner side of the lock 2 above the inside door handle 6. The thumb turn 7 includes an operating knob 70. The thumb turn 7 is rotatable 45 degrees in both the clockwise and anticlockwise directions using this knob 70. The thumb turn 7 is coupled to a bolt 9 for permanent locking (hereinafter, “deadbolt”) provided on a lateral side of the lock 2.

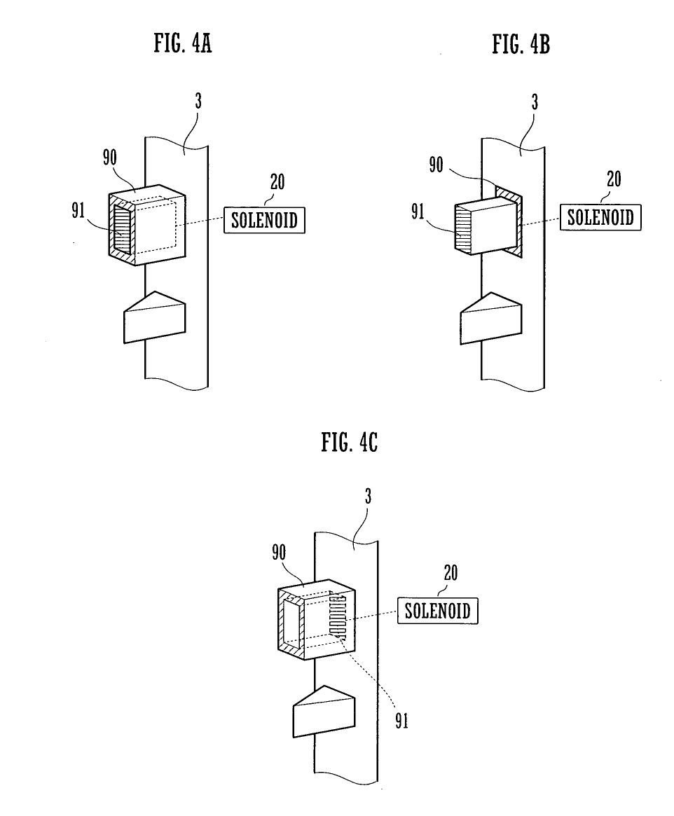

The deadbolt 9 has a dual structure as shown in FIGS. 4A to 4C. That is, the deadbolt 9 is configured with an outer bolt 90 and an inner bolt 91 that is slidable back and forth inside the outer bolt 90. The outer bolt 90 can be projected from the lock 2 by rotating the key 1 inserted in the cylinder 5. The outer bolt 90 can also be projected from the lock 2 by rotating the thumb turn 7 45 degrees with the outer bolt 90 retracted into the lock 2. Conversely, the outer bolt 90 can be retracted into the lock 2 by rotating the thumb turn 7 45 degrees in the opposite direction with the outer bolt 90 projecting from the lock 2.

The inner bolt 91 is reciprocated by a solenoid 20 provided in the lock 2. The solenoid 20 is activated when fingerprint authentication is established with the inner bolt 91 in a projected state, retracting the inner bolt 91 into the lock 2. Conversely, when the solenoid 20 is activated with the inner bolt 91 retracted into the lock 2, the inner bolt 91 is projected. Rotating the thumb turn 7 when the outer bolt 90 and the inner bolt 91 are in a locked state also activates the solenoid 20.

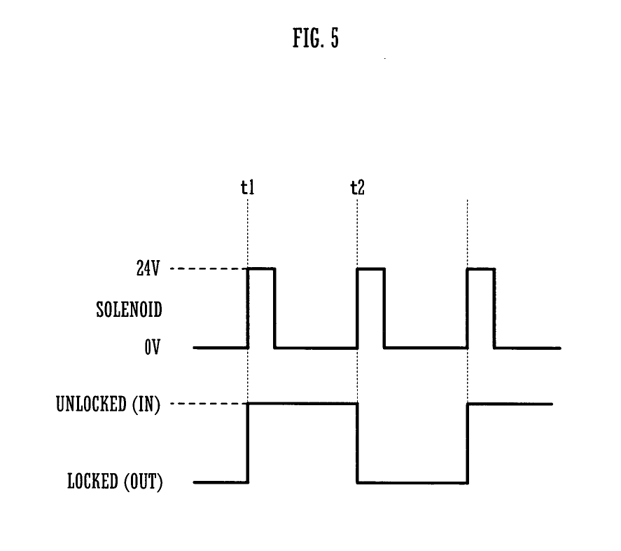

FIG. 5 shows the relation between the flow of current to the solenoid 20 and locking/unlocking by the inner bolt 91. When there is an instantaneous flow of current to the solenoid 20 at t1 in a locked state, the inner bolt 91 is retracted into the lock 2 and the door is unlocked. Again, when there is an instantaneous flow of current to the solenoid 20 at t2 in an unlocked state, the inner bolt 91 is projected and the door is locked.

Locking is realized by projecting either or both of the outer bolt 90 and the inner bolt 91. FIG. 4A shows both the outer bolt 90 and the inner bolt 91 in a projected state, while FIG. 4B shows the inner bolt 91 in a projected state, and FIG. 4B shows the outer bolt 90 in a projected state.

Consequently, if fingerprint authentication is established at the same time that the key 1 is inserted into the cylinder 5 and rotated, in a locked state with both the outer bolt 90 and the inner bolt 91 projecting as shown in FIG. 4A, that is, with the door fully locked by the deadbolt 9, both the outer bolt 90 and the inner bolt 91 are retracted into the lock 2 and the door is unlocked. If fingerprint authentication is not established in this case, only the outer bolt 90 is retracted into the lock 2 as shown in FIG. 4B, and the locked state is maintained. If fingerprint authentication is established without the key 1 inserted in the cylinder 5 being rotated, only the inner bolt 91 is retracted into the lock 2, with the outer bolt 90 remaining in a projected state, as shown in FIG. 4C. The locked state is also preserved in this case. When the thumb turn 7 is rotated in the state shown in FIG. 4A, the outer bolt 90 and the inner bolt 91 are retracted into the lock 2 unconditionally, and the door is unlocked.

A microswitch 21 that detects the in/out state of the deadbolt 9 is provided inside the lock 2. The microswitch 21 outputs a locked signal if one or both of the outer bolt 90 and the inner bolt 91 of the deadbolt 9 are projecting, and outputs a unlocked signal if both the outer bolt 90 and the inner bolt 91 are retracted within the lock 2.

A reed switch 22 is provided below the latch bolt 8. A magnet (not shown) is disposed on a wall facing the reed switch 22 with the door 3 properly closed. Consequently, when the door 3 is closed, the reed switch 22 is activated and a door closed signal is output, and when the door 3 is opened, the reed switch 22 is deactivated and a door open signal is output.

A display unit 23 is provided to the right of the cylinder 5. This display unit 23 displays the result of the fingerprint authentication, being “OK” or “NG”, for example. The display unit 23 also displays warnings and the like if necessary. A setting display operation unit 26 is provided above the inside door handle 6 located on the inside of the door 3. If the door 3 is not closed within a given period of time after being unlocked and opened, the setting display operation unit 26 performs a display indicating this state and issues a warning by buzzer. It is also possible to perform prescribed data settings relating to locking/unlocking in cooperation with a connected host CPU that is not shown.

Note that with the above configuration, the size of the deadbolt 9 in terms of external form can be kept the same as deadbolts normally used because of the deadbolt 9 being configured with the outer bolt 90 and the inner bolt 91. Thus, the size and positioning of the wall cavity inserted for the deadbolt 9 remain unchanged, making it possible to exchange the locking device of the present embodiment directly for an existing locking device. Also, the outer bolt 90 may be moved by the solenoid 20, and the inner bolt 91 may be moved by the key 1 or the thumb turn 7. Further, the deadbolt 9 may have the same structure as those normally used, and a separate deadbolt that is moved by the solenoid 20 may be provided instead of the inner bolt.

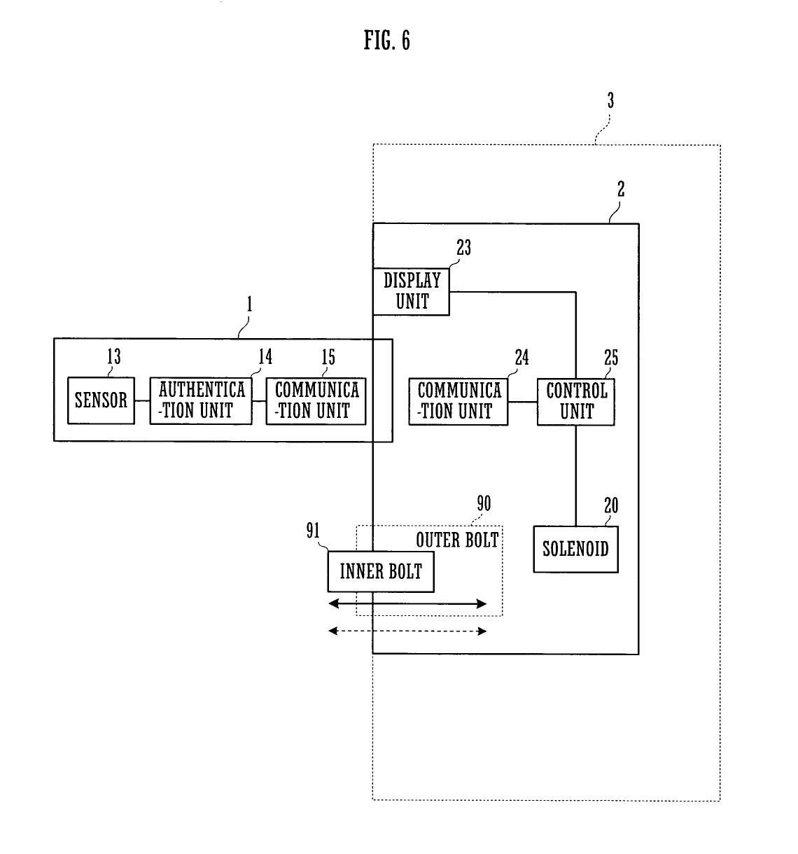

FIG. 6 shows the main configuration of the key 1 and the lock 2.

The lock 2 includes a communication unit 24 that transmits and receives data with the communication unit 15 of the key 1 using a contactless communication system, the display unit 23 for displaying fingerprint authentication results, the solenoid 20 for moving the inner bolt 91 back and forth, and a control unit 25 that controls these constituent elements. With the contactless communication system, a carrier wave is sent from the communication unit 24 to the communication unit 15 of the key 1. The communication unit 15 acquires power by converting the carrier wave to electricity, and also sends data (fingerprint authentication result) to the communication unit 24 by modulating the carrier wave. Alternatively, a small battery may be incorporated in the key 1, and a carrier wave modulated with data (fingerprint authentication result) transmitted from the communication unit 15 to the communication unit 24.

The control unit 25 displays “OK” or “NG” on the display unit 23, based on the above data (fingerprint authentication result). Also, the inner bolt 91 of dead bolt 9 is moved back and forth (projected and retracted) by driving the solenoid 20.

Note that while communication between the key 1 and the lock 2 is performed with a contactless communication system, it is also possible to adopt a contact communication system in which an electrical terminal is provided on both the key 1 and the lock 2, and data is transmitted through contact of these electrical terminals. Other methods may also be employed, such as an IrDA (Infrared Data Association) system utilizing infrared.

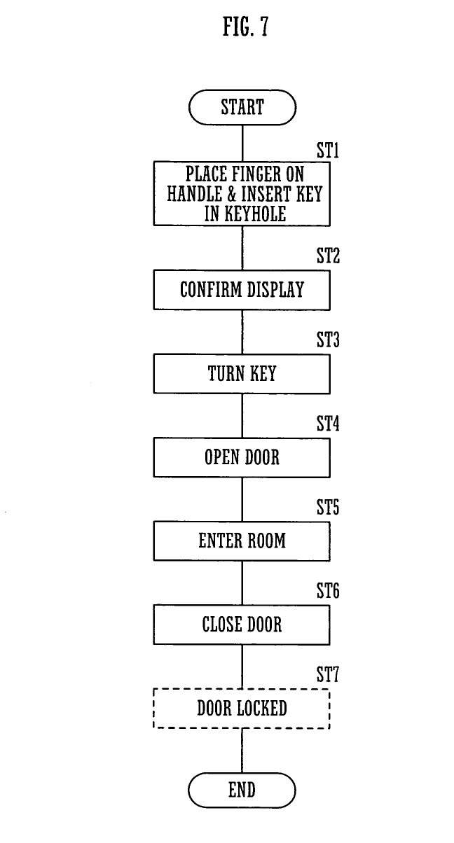

The operation of the lock is described next with reference to FIG. 7 and below.

FIG. 7 is a flowchart showing the operating procedure when an operator (hereinafter, “the user”) enters a room.

A user who wants to enter a room places a prescribed part of a finger targeted for authentication on the fingerprint sensor 13 located on the surface of the handle 11 of the key 1, and puts the key 1 into the keyhole of the cylinder 5 (step ST1). The user confirms that “OK” is displayed on the display unit 23 (step ST2), and turns the key 1 (step ST3). When the door 3 is unlocked, the user turns the outside door handle 4 and opens the door 3 (step ST4). The user enters the room (step ST5) and closes the door 3 (step ST6). If the door is self-locking, the processing proceeds to step ST7 and the door 3 is automatically locked. If “NG” is displayed on the display unit 23 in step ST2, the door is not unlocked because the inner bolt 91 on the inner side of the deadbolt 9 is not retracted.

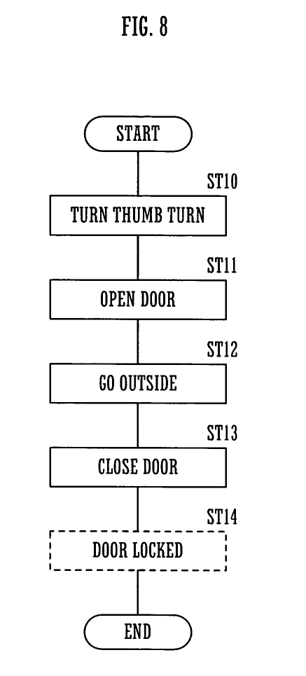

FIG. 8 is a flowchart showing the operating procedure when a user leaves a room.

A user who wants to leave a room turns the thumb turn 7 (step ST10), retracting the deadbolt 9 and unlocking the door 3. The user then turns the handle 6 to open the door 3 (step ST11), goes outside (step ST12), and closes the door 3 (step ST13). If the door is self-locking, the processing proceeds to step ST14 and the door 3 is automatically locked.

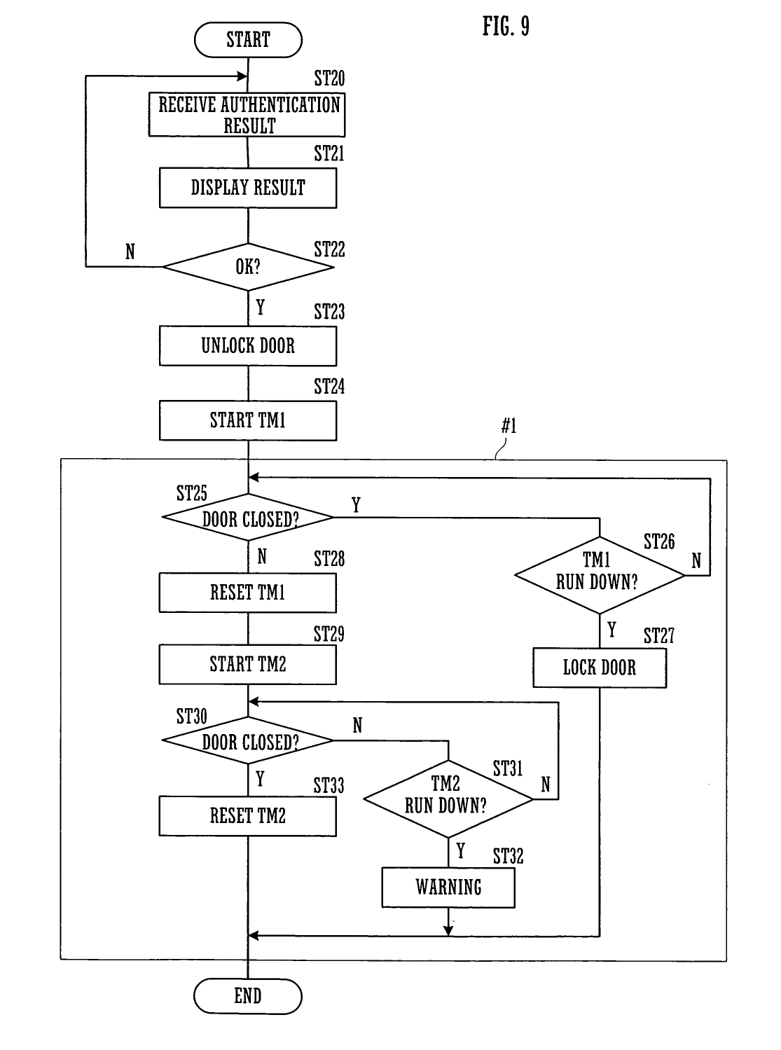

FIG. 9 is a flowchart showing the main operating procedure of the control unit 25.

Unlocking Operation when User Enters Room

Assume that the door 3 is now closed and the deadbolt 9 is in a projected state, locking the door 3. A user who wants to enter the room places a prescribed part of a finger targeted for authentication (e.g., the ball of the thumb) on the fingerprint sensor 13 located on the surface of the handle 11 of the key 1, and puts the key 1 into the keyhole of the cylinder 5.

The fingerprint sensor 13 detects the fingerprint of the finger pressed against a fingerprint collection surface, and sends the detected fingerprint to the authentication unit 14. The authentication unit 14 starts collating the fingerprint detected by the fingerprint sensor 13 (detected fingerprint) with the fingerprint registered in advance (registered fingerprint), and the authentication result obtained from the collation is sent from the communication unit 15 to the control unit 25 of the lock 2 via the communication unit 24 of the lock 2 (step ST20).

The control unit 25 displays “NG” on the display unit 23 if the detected fingerprint and the registered fingerprint do not match, and displays “OK” on the display unit 23 if the detected fingerprint and the registered fingerprint match (step ST21).

If the authentication result is “OK” (step ST22=YES), the control unit 25 supplies an instantaneous flow of current to the solenoid 20. As a result, the inner bolt 91 on the inner side of the deadbolt 9 is retracted (step ST23), and on condition that mechanical authentication is also established, that is, on condition that the key portion 10 (see FIG. 1) and the lock are the correct combination, the outer bolt 90 is also retracted when the key is turned and the door 3 is unlocked. In this way, the user is able to perform an unlocking operation on the door 3.

When the door 3 is unlocked, the control unit 25 starts a soft timer TM1 running (step ST24). The control unit 25 checks whether or not the door 3 has been opened based on the signal from the reed switch 22 (step ST25). If the door 3 has not been opened before the soft timer TM1 runs down (step ST26=YES), the control unit 25 supplies an instantaneous flow of current to the solenoid 20, projecting the inner bolt 91 on the inner side of the deadbolt 9 and locking the door 3 (step ST27).

If the door 3 is opened before the soft timer TM1 runs down (step ST26=NO), the control unit 25 resets the soft timer TM1 (step ST28), and starts a soft timer TM2 running (step ST29). The control unit 25 checks whether or not the door 3 has been closed based on the signal from the reed switch 22 (step ST30).

If the door 3 has not been closed by the time the soft timer TM2 runs down (step ST31=YES), the control unit 25 controls the setting display operation unit 26 to perform a display indicating that the door 3 has been left open and issue a warning by sounding a buzzer (step ST32). If the door 3 is closed before the soft timer TM2 runs down (step ST30=YES), the control unit 25 resets the soft timer TM2 (step ST33), and ends the series of unlocking operations.

Note that the processing of steps ST24 to ST33 (block#1 processing) in the flowchart shown in FIG. 9 may be omitted.

Instead, a self-locking mechanism may be activated when the door 3 is closed.

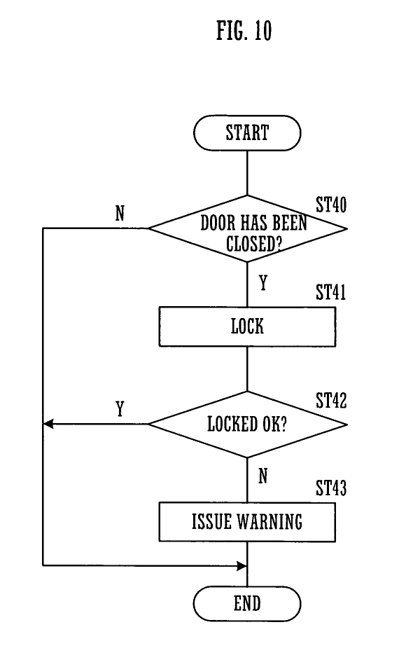

FIG. 10 shows a flowchart in the case where a self-locking mechanism is activated.

The processing moves to the FIG. 10 procedure after the door 3 has been unlocked at step ST23 in FIG. 9.

The control unit 25 confirms that the door 3 has been closed, as the result of a door closed signal from the reed switch 22 (step ST40=YES). The control unit 25 supplies an instantaneous flow of current to the solenoid 20, which projects the inner bolt 91 and locks the door 3 (step ST41).

The control unit 25 checks whether or not the door 3 has actually been locked based on a signal from the microswitch 21 (step ST42). If the door 3 has not been locked, that is, if a locked signal has not been sent from the microswitch 21, the setting display operation unit 26 issues a warning by means of a display and by sounding a buzzer, et cetera. (step ST43).

Self-locking is possible not only when the user enters the room, but also when he or she leaves the room. In this case, the setting display operation unit 26 issues a warning by means of a display on the display unit 23 and by sounding a buzzer, et cetera in step ST43 of FIG. 10.

The procedure for registering fingerprint information is described next.

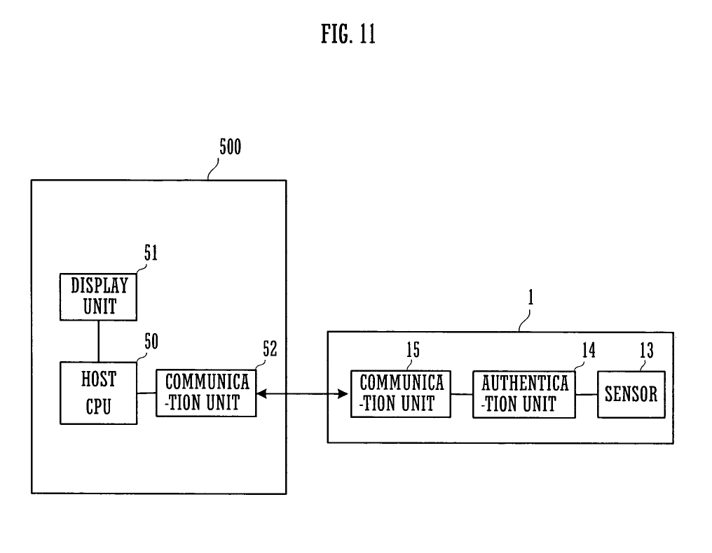

In the present embodiment, fingerprint information can be registered in the memory in the authentication unit 14 of the key 1 using a fingerprint information registration device. The fingerprint information registration device is installed in a hotel lobby, for example. FIG. 11 is a block diagram of the fingerprint information registration device installed as a hotel terminal in a hotel lobby.

The key 1 includes the fingerprint sensor 13, the authentication unit 14, and the communication unit 15. A fingerprint information registration device 500 is connected to a superordinate host in the hotel, and includes a host CPU 50, a display unit 51, and a communication unit 52.

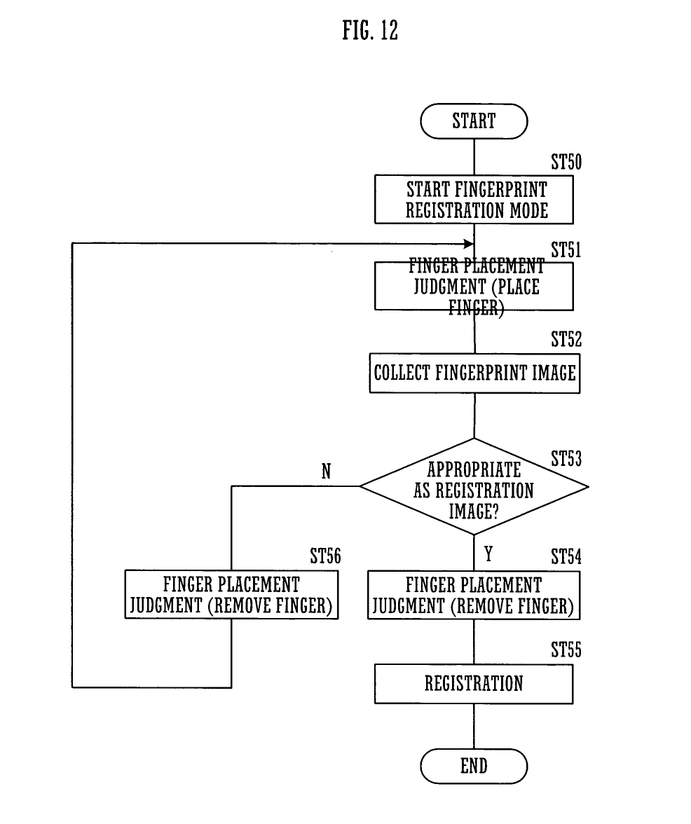

Fingerprint information is registered by placing the key 1 lent to the hotel user on a prescribed position of the fingerprint information registration device 500, for example, during check-in of the hotel user, and executing a registration mode. FIG. 12 is a flowchart showing the operation procedure of the fingerprint information registration device 500 when in the fingerprint registration mode.

When the fingerprint information registration device 500 starts executing the fingerprint registration mode (step ST50), the display unit 51 performs a display indicating to place a finger for registering on the fingerprint sensor 13. The user (fingerprint information registree) places a finger for registering on the fingerprint sensor 13 (step ST51). The authentication unit 14 collects fingerprint information (step ST52), and judges whether there is a problem with the collected information as a result of scratches, scars or the like (step ST53). If there is a problem, the display unit 51 performs a display indicating to temporarily remove the finger from the fingerprint sensor 13 (step ST56). The operations from step ST51 down are then performed again. If there is not a problem with the collected information, the display unit 51 performs a display indicating to remove the finger from the fingerprint sensor 13 because fingerprint information has been collected without problems (step ST54). When the user (fingerprint information registree) removes his or her finger from the fingerprint sensor 13, the authentication unit 14 extracts a characterizing part from the collected fingerprint information, and registers the extracted characterizing part in the memory of the authentication unit 14 (step ST55).

A separate fingerprint sensor or the like for use in registration does not need to be provided, since the fingerprint sensor 13 and the authentication unit 14 of the key 1 used in fingerprint authentication are also used to register fingerprint information, as described above.

As another working example, the fingerprint information registration device 500 can also be rendered redundant by making it so that the registration mode can be executed using the setting display operation unit 26 shown in FIG. 3. For example, the lock 2 is placed in the state shown in FIG. 4C in which only the outer bolt 90 is locked at the initial stage of the lock 2, and a password for executing the registration mode is assigned to the user. Since the door 3 will open as a result of the outer bolt 90 being unlocked when the user inserts the key 1 in the cylinder 5 and rotates the key 1, the setting display operation unit 26 on the inside of the door collates the password input using the operation unit 26 and sets the registration mode, with the key 1 inserted in the cylinder 5 (the user inputs the password using the numeric keyboard of the setting display operation unit 26). Next, a characterizing part of the fingerprint information collected by the fingerprint sensor 13 is extracted and registered in the memory in the authentication unit 14 as a result of communication between the key 1 and the setting display operation unit 26.

As yet another working example, the authentication unit 14 of the key 1 may itself be made to perform the extraction and registration of fingerprint information performed by the fingerprint information registration device 500 or the setting display operation unit 26.

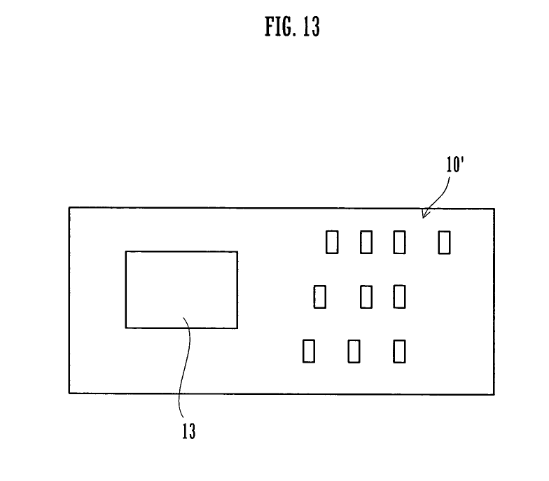

While the key portion 10 of the key 1 in the foregoing embodiment has an irregular structure, a key portion 10 may be constituted with a distribution pattern of punched holes, as shown in the FIG. 13. Using this distribution pattern, it is possible to perform mechanical authentication as to whether or not the key 1 and the lock 2 are the correct combination. In this case, the lock 2 includes a light irradiation unit for irradiating light onto the openings in the punched holes, and also a light receiving unit for receiving light that passes through the punched holes. Security can be improved for individual users by changing the punched holes, making this configuration advantageous in the case of there being an unspecified number of users, such as with hotels and the like.

Note that methods for authenticating whether the key portion 10 of the key 1 and the lock 2 are the correct combination include those that use other media such as magnetism and radio waves, the present invention also being applicable in locking devices that adopt these methods. Further, other sensors can also be used provided they are able to acquire biometric information at the same time that a key operation is performed. For example, it is also possible to use a sensor that acquires biometric information on the vein pattern of fingers, instead of a fingerprint sensor.

What is claimed is:

1. A locking device for performing unlocking by an insertion of a key into a lock, the key comprising:
a biometric information acquisition sensor that acquires biometric information of an operator;
an authentication unit that authenticates the operator based on biometric information acquired by the sensor when the key is inserted into the lock; and
a transmitting unit that transmits a result of the authentication performed by the authentication unit to the lock, and
the lock comprising:
a receiving unit that receives the authentication result transmitted from the transmitting unit; and
an unlocking unit that performs unlocking when both the authentication result received by the receiving unit is information showing that authentication of the operator was established, and the inserted key and the lock are the correct combination.

2. The locking device according to claim 1, wherein
the key has a plurality of punched holes in a portion thereof inserted into the lock, and
the unlocking unit includes:
a detecting unit that detects a distribution pattern of the punched holes; and
a judging unit that judges whether the key and the lock are the correct combination based on the distribution pattern of the punched holes detected by the detecting unit.

3. The locking device according to claim 1, wherein
the biometric information acquisition sensor acquires fingerprint information as the biometric information.

4. The locking device according to claim 1, wherein
the transmitting unit and the receiving unit each include a contactless communication unit that performs contactless communication.

5. The locking device according to claim 1, wherein
the authentication unit includes a storage unit that stores the biometric information acquired by the biometric information acquisition sensor, and
the authentication unit authenticates the operator by comparing the biometric information acquired by the sensor when the key is inserted into the lock with the biometric information stored in the storage unit.

6. A key comprising:
a fingerprint information acquisition sensor that acquires fingerprint information of an operator;
an authentication unit that authenticates the operator based on fingerprint information acquired by the sensor when the key is inserted into a lock; and
a transmitting unit that transmits a result of the authentication performed by the authentication unit to the lock.

7. The locking device according to claim 6, wherein
the authentication unit includes a storage unit that stores the fingerprint information acquired by the fingerprint information acquisition sensor, and
the authentication unit authenticates the operator by comparing the fingerprint information acquired by the sensor when the key is inserted into the lock with the fingerprint information stored in the storage unit.
